(19) United States
(12) Patent Application Publication
(10) Pub. No.: US 2002/0150649 A1
(43) Pub. Date: Oct. 17, 2002

(54) Nutritional supplement for pediatric obesity

(76) Inventor: Stacey J. Bell, Belmont, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 09/783,724

(22) Filed: Feb. 14, 2001

(51) Int. Cl. A23L 1/00

(52) U.S. Cl. 426/2

(57) ABSTRACT

Nutritional supplements and methods to aid with the management of weight loss for overweight and obese pediatric patients are described. The nutritional supplement comprises a low-glycemic-index carbohydrate source, a source of protein and a source of fat. The nutritional supplement may be in the form of an extruded bar, powder or beverage.

### BACKGROUND OF THE INVENTION

The prevalence of obesity in children and adolescents has increased rapidly over the past 30 years in the United States and globally and continues to rise. Obesity is classically defined based on the percentage of body fat or, more recently, the body mass index (BMI), also called Quetlet index (National Task Force on the Prevention and Treatment of Obesity, Arch. Intern. Med., 160: 898-904 (2000); Khaodhiar, L. et al., Clin. Cornerstone, 2: 17-31 (1999)). The BMI is defined as the ratio of weight (kg) divided by height (in meters) squared.

Since many of the drugs available to adults for combating obesity are not appropriate for children, only diet, exercise and behavior change are left as treatments. Some teens have reportedly sought out dangerous alternative products such as ephedrine, phenylpropanolamine (which was recently withdrawn), or potentially worse, smoking (Pray W. S., U.S. Pharmacist; 25:1-4 (2000); Tomeo C. A. et al., Pediatrics 104:918-924 (1999)).

A low-fat diet to treat obesity has been recommended, but epidemiological studies do not show consistently that low-fat diets work (Ludwig D. S., J Nutr. 130:280S-283S (2000)). Moreover, mean fat intake in the U.S. has decreased since the 1960s from 42% to 34% of dietary energy, whereas the prevalence of overweight has risen in children and adolescents. Clearly new options are needed to help children and adolescents lose weight and maintain the weight loss.

### SUMMARY OF THE INVENTION

The invention pertains to nutritional supplements and methods for help with the management of weight loss for overweight and obese child or adolescent patients, collectively referred to herein as “pediatric patients”. The nutritional supplement comprises a low-glycemic-index carbohydrate source, a source of protein and a source of fat. The low-glycemic-index carbohydrate when administered to the pediatric patient increases satiety, delays the return of hunger and decreases ad libitum food intake.

The nutritional supplement can contain a carbohydrate source selected from the following: fructose, barley flakes, konjac mannan, psyllium and combinations thereof. The protein source is of a high biological value and is selected from whey protein concentrate, casein, soy, milk, egg and combinations thereof. The fat of the nutritional supplement is a non-atherogenic oil, preferably a vegetable oil comprising at least one vegetable oil selected from the group consisting of: canola, olive, soy, safflower, sunflower, corn and combinations thereof.

The nutritional supplement, additionally may comprise one or more of the following: micronutrients, dietary supplements, vitamins, minerals, flavoring, nutrients, and edible compounds, or a emulsifier.

In preferred embodiments, the nutritional supplement comprises, for a 20 to 75 grams serving, from about 1 to about 75 grams low-glycemic-index carbohydrate (e.g., one or more low-glycemic-index carbohydrates that may further provide a source of dietary fiber), from about 1 to about 15 grams protein and from about 1 to about 20 grams fat. The ranges used herein are based upon a single serving. Two or more servings may be taken each day, especially for older children. Vitamins and minerals in amounts recommended daily to supplement the diet can also be optionally added.

The nutritional supplement can be made in a variety of forms, such as pharmaceutical compositions (e.g., tablet, powder, suspension, liquid, capsule, gel), nutritional beverages, puddings, confections (i.e., candy), ice cream, frozen confections and novelties, or non-baked, extruded food products such as bars. In another embodiment, the ingredients of the nutritional supplement can be administered separately, such as by incorporating certain components (e.g., bitter tasting ones) into a capsule or tablet and the remaining ingredients are provided as a powder or nutritional bar. The preferred form of the nutritional supplement is a nutritional beverage or a nutritional bar, such as a non-baked, extruded snack bar. The supplement can be formulated for single or multiple daily administration, at least once a day, taken mid-afternoon (such as after-school) and after dinner, so as to control intake at the subsequent meal and satiety to appetite between meals or at night.

Methods are also described for providing a pediatric individual with nutritional supplementation that aids in the feeling of satiety by administering a nutritional supplement comprised of low-glycemic-index carbohydrate, protein and fat, more preferably in the form of a liquid (e.g. beverage). Also described are methods for providing a pediatric individual with nutritional supplementation that aids in the management and/or prevention of weight gain and promotes weight loss.

### DETAILED DESCRIPTION OF THE INVENTION

A description of preferred embodiments of the invention follows.

The invention pertains to a nutritional supplement for overweight and obese children and adolescents, comprising a low-glycemic-index carbohydrate source, a source of protein and a source of fat. Based on clinical studies, the use of low-glycemic-index carbohydrates curb appetite and cause a reduction in daily caloric intake. As used herein the term “overweight” embraces obesity and is defined by commonly recognized clinical guidelines, such as BMI. These nutritional supplements when used with a weight loss program, will facilitate weight loss and maintenance. The nutritional supplement may be in the form of an extruded bar or liquid, more preferably, a beverage or food.

The low-glycemic-index carbohydrate source can be provided by a single carbohydrate or a combination. The carbohydrate source can further provide a source of fiber and maybe fructose, barley flakes, konjac mannan, psyllium and combinations thereof. The protein source is of a high biological value and is selected from at least one of the following: whey protein concentrate, casein, soy, milk, egg and combinations of these. The fat is a non-atherogenic oil, preferably one of the following: canola, olive, soy, safflower, sunflower, corn and combinations of these. Additionally, the nutritional supplement may contain, micronutrients, vitamins, minerals, dietary supplements (e.g., herb), nutrients, emulsifiers, flavorings and edible compounds.

In a preferred embodiment, the nutritional supplement for overweight and pediatric individuals comprises, for a 100 to 200 kcal/serving, with 130 kcal serving being most preferred, from about 1 to about 75 gramslow-glycemic-index carbohydrate, from about 1 to about 20 grams protein and from about 1 to about 20 grams fat.

In yet another embodiment, the nutritional supplement comprises for a 120-125 kcal serving, from about 10 to about 30 grams low-glycemic-index carbohydrate, from about 1 to about 5 grams protein and from about 1 to about 5 grams fat.

For the purposes of this invention, a preferred nutritional supplement comprises the components described above as a single serving (serving unit), whereby one or a plurality (preferably, more than one) of these supplement(s) is (are) consumed daily. The proportions of these ingredients are based on a 27 gram serving. Two servings make up about 240-250 kcal. In a preferred embodiment, each serving (serving size) contains 120-125 kcal. Other serving sizes are contemplated in the invention. The total amount of each ingredient should be appropriately adjusted.

The use levels for ingredients incorporated into the nutritional supplement are illustrated in the chart below in relation to a serving size of bar and represents broadest, preferred and most preferred embodiments. All ranges are approximate.

| Nutrients | Optimal | Preferred | Most Preferred |
|---|---|---|---|
| (per serving) | Amount | Range | Range |
| Carbohydrate | 1-75 g | 10-30 g total | 21 g total |
| | 2 g other | | |
| | (e.g. flavorings, | | |
| | colors) | | |
| Protein | 1-50 g | 1-5 g | 3 g |
| Fat | 1-20 g | 1-5 g | 3 g |

The ingredients that make up the nutritional supplement are described in detail below and with regard to their relative role each contributes to therapeutic advantages of the invention.

Low-Glycemic-Index Carbohydrates

An important macronutrient of the nutritional supplement is carbohydrate because it has the greatest influence on satiety and subsequent weight loss. As used herein, satiety, refers to the sensation of fullness between one meal and the next and satiation refers to a sensation of fullness that develops during the progress of a meal and contributes to meal termination. Foods with low-glycemic-indexes evoke a smaller rise in blood glucose and insulin and a higher glucagon concentration, which promote satiety and prevent weight gain better than those carbohydrate-containing foods with higher ones because they take longer to digest and to be absorbed than carbohydrates with high-glycemic-indices (Expert Panel, National Institute of Health, Heart, Lung, and Blood Institute, 1-42 (June 1998)).

The “glycemic index” is a system of predicting subsequent rises in blood glucose after ingestion of carbohydrate-containing foods (Anderson, J. S. et al., Modern Nutrition in Health and Disease, ch. 70: 1259-86 (1994); Wolever, T. M. S. et al., Am. J. Clin. Nutr., 54: 846-54 (1991); Wolever, T. M. S. et al., Diab. Care, 12: 126-32 (1990)). The glycemic index characterizes the rate of carbohydrate absorption after a meal. It is defined as the area under the glycemic response curve during a 2-hour period after consumption of 50 g of carbohydrate from a test food divided by the area under the curve of a standard, which is either white bread or glucose. The glycemic index carbohydrates have the highest peak circulating glucose in a 2 hour period following ingestion of food. Conversely, low-glycemic-index carbohydrates cause a lower peak glucose and smaller area under the curve.

Many factors determine the glycemic index of foods. These include carbohydrate type, fiber, protein and fat content and the method of preparation (overcooked foods evoke a higher response). Generally high-glycemic-index carbohydrates are highly refined, and have a relatively high amount of glucose or starch compared to lactose, sucrose or fructose. Also, they are low in soluble fiber. The inclusion of fiber is important due to the way fiber facilitates weight loss by forming a gel with the food in the stomach. This gelling action reduces the rate of gastric emptying and hence digestion rates which promote satiety. Other factors which affect satiety are the amount of carbohydrate, the complexity of the carbohydrate, and the other foods that are eaten simultaneously with the carbohydrate (e.g., fiber, protein, fat) (Ludwig, D. S., J. Nutr., 130: 280S-3S (2000); Wolever, T. M. S. et al., Am. J. Clin. Nutr., 54: 846-54 (1991); Wolever, T. M. S. et al., Diab. Care, 12: 126-32 (1990)). Bread and potatoes raise blood glucose more than beans. Other foods containing no or non-digestible carbohydrate ingested at the same time as carbohydrates (e.g., fat, fiber and protein) reduces postprandial blood glucose and insulin levels (Wolever, T. M. S. et al., Am. J. Clin. Nutr., 54: 846-54 (1991)).

The hormonal profile created from consumption of low-glycemic-index carbohydrates and fiber is a low glucose and insulin response and a high glucagon response (Expert Panel, National Institute of Health, Heart, Lung, and Blood Institute, 1-42 (June 1998)). The opposite effect is seen with high-glycemic-index carbohydrates. In particular, there is a rapid decline in blood glucose concentrations following a meal of high-glycemic-index carbohydrates as a result of the extreme counter regulatory hormones that are activated to normalized high levels of circulating glucose. These high-glycemic-index carbohydrates promote the uptake of glucose into the muscle, prevent gluconeogenesis from occurring in the liver, and inhibit lipolysis, thereby denying the body access to two major fuels, glucose and fat. After consumption of high glycemic index carbohydrates, the hormonal state created is similar to what occurs with the lack of food for several hours, the decrease in blood glucose and free fatty acids that induce hunger.

In addition, the ingestion of high-glycemic-index carbohydrates is undesirable because, calorie for calorie, these carbohydrates elicit higher insulin levels and c-peptide excretion than low-glycemic-index carbohydrates. This functional hyperinsulinemia may promote weight gain by preferentially directing nutrients away from oxidation in the muscle and toward storage as fat.

Insulin response may be more important than the glycemic response in weight loss, although the two are highly correlated (Holt, S. H. A. et al., Am. J. Clin. Nutr., 661: 1264-76 (1997)). Some foods elicit a greater insulin response than glycemic response. Similarly, eating carbohydrate-rich and protein-rich foods at the same meal increases the postprandial insulin response (Slabber, M. et al., Am. J. Clin. Nutr., 60: 48-53 (1994)).

Consumption of low-glycemic-index carbohydrates promotes weight loss through energy intake regulation (Ludwig, D. S., J. Nutr. 130:280S-283S (2000); Roberts, S. R., Nutr. Rev. 58:163-169 (2000)). Increased satiety, a delay in return to a state of hunger and a decrease in food intake at a subsequent meal occurs with ingestion of low-glycemic-index carbohydrates.

The most powerful influence of low-glycemic-index carbohydrates appears to be in the reduction of energy intake at subsequent meals (Roberts S. R., Nutr. Rev. 58:163-169 (2000)). Energy intake averaged 29% more after consumption of high glycemic index carbohydrates compared to low-glycemic-index carbohydrates. Studies in which the effect of different glycemic indexed have on satiety and satiation have produced conflicting results. Many of the studies had design flaws such as short duration and variability of test diets (differences in energy density of paplatablilty) to establish a true result.

The use of low-glycemic-index carbohydrates for weight reduction has been evaluated twice in the pediatric population (Ludwig, D. S. et al., Pediatrics 102:e26 (1999); Spieth, L. E., et al., Arch Pedi. Adolesc. Med, 154:947-951 (2000)). In the Ludwig study, twelve adolescent pubertal boys (mean age 15.4±1.4 years) were evaluated on three separate occasions. The subjects consumed identical test meals at breakfast and lunch that had low, medium or high-glycemic-index carbohydrates. Ad libitum food intake was determined 5 hours after lunch. Voluntary energy intake after the high-glycemic-index meal was 53% greater that after the medium-glycemic-index meal and 81% greater that after the low-glycemic-index mean. In addition, compared to the low-glycemic-index mean, the high-glycemic-index meal resulted in higher serum insulin levels, lower plasma glucagon levels, lower postabsorptive plasma glucose and serum fatty acid levels, and evaluation of plasma epinephrine. The area under the glycemic response curve accounted for 53% of the variation in voluntary food intake. The hormonal and metabolic changes, resulting from rapid absorption of glucose following the high-glycemic-index meal, were thought to promote excessive food intake in obese subjects.

The second study, conducted by Spieth et al. was designed to compare the long term effects of a low-glycemic-index diet with a low-fat diet on weight loss. Subjects were given diet instructions, based on which group they were assigned to and exercise and behavioral change information. Besides differences in glycemic index, the diets differed in the percentage of energy contributed by fat. For the low-fat group, the goal was to consume 25-30% of energy as fat and in the low-glycemic-index group 30-35%. Those in the low-glycemic-index group were told to eat to satiety, rather than being told to restrict intake of certain foods. Those in the low-fat diet group were directed to restrict intake of certain foods. Both body weight and BMI decreased significantly more in the low glycemic group, even after adjusting for age, sex, ethnicity, baseline BMI or body weight. Conversely, no change in BMI occurred in the low fat diet group.

Patients who also eat a diet rich in low-glycemic-index carbohydrates will have the best results (Expert Panel, National Institute of Health, Heart, Lung, and Blood Institute, 1-42 (June 1998)). This diet includes foods rich in vegetables, fruits, and legumes, moderate amounts of protein and healthful fats, and a decreased intake of refined grain products, potato, and concentrated sugars.

Based upon this understanding, the nutritional supplement will comprise one or more sources of carbohydrates having a low-glycemic-index and a source of fiber. In a preferred embodiment, the carbohydrate has a low-glycemic-index and provides a source of fiber comprising about 1 to about 75 g carbohydrate per serving. Two servings per day are needed at this use level. The preferred range is about 10 to about 30 g of low-glycemic-index carbohydrate per serving, more preferably, about 21 g per serving.

Fructose is a preferred carbohydrate for sweetening the nutritional supplement. It is sweeter than ordinary table sugar (sucrose), derived from beet or cane sugars, and has a low-glycemic-index (GI=32). Taken as part of a meal, fructose produces a smaller incremental rise in plasma glucose level does sucrose, glucose, potato starch or wheat starch.

In preferred embodiments, it is desirable to incorporate barley (e.g., barley flakes) into the nutritional supplement as a low-glycemic-index carbohydrate and fiber source. Of all the grains, certain forms of barley have some of the lowest glycemic indexes. Pearled barley (GI=36) and cracked barley (GI=72) have lower glycemic indexes than sweet corn (GI=78), rolled barley (GI=94), and instant white rice (GI=128). Further, it is desirable to use barley with its bran still on it (referred to as “hulless barley”), so that the naturally occurring fiber remains. Thus, it provides a low glycemic source of carbohydrate and a source of fiber (14%), both of which are advantageous in maintaining good glucose and weight control.

Konjac flour, which comes from a perennial tuber called Amorphophallus konjac, is a dietary fiber (90%) and a polysaccharide with a very high molecular weight. In addition, this glucomannan hydrocolloid has the ability to increase the viscosity of the intestinal fluid (digesta), thereby limiting the transport of glucose into the bloodstream (Vuksan, V. et al, submitted for publications, (2000)). Konjac mannan also has a low glycemic index, promoting weight loss by increasing satiety in obese and non-obese patients with type 2 diabetes (Doi, K. et al, Progress in Obesity Research, ch. 80: 507-14, (1990)). In preferred embodiments, the nutritional supplement should provide from about 1 g to about 10 g konjac per serving; with about 1 g of konjac mannan being preferred.

A good source of carbohydrate providing fiber for use in the nutritional supplement is psyllium. Psyllium husk fiber is a viscous, mostly water-soluble fiber prepared from blonde psyllium seed (Plantago ovata). Psyllium, because it is a dietary fiber, promotes satiety and minimizes weight gain (Ludwig, D. S. et al., Modern Nutrition in Health and Disease, ch. 70: 1259-86 (1994)). It also has been shown to reduce blood lipid concentrations and blood glucose levels (Anderson, J. W. et al., Am. J. Clin. Nutr., 70: 466-73 (1999); Anderson, J. W. et al., Am. J. Clin. Nutr., 71: 1433-8 (2000); Anderson, J. W. et al., Am. J. Clin. Nutr., 71: 472-9 (2000)). Psyllium can be added in amounts of from about 1 g to about 10 g per serving based upon a 10-15 g serving. This, in conjunction with other soluble fiber consumed through a healthy diet, will contribute to controlling appetite and weight gain.

Protein

Sources of protein can be any suitable protein utilized in nutritional formulations and can include whey protein, whey protein concentrate, whey powder, egg, soy protein, soy protein isolate, caseinate (e.g., sodium caseinate, sodium calcium caseinate, calcium caseinate, potassium caseinate), animal and vegetable protein and mixtures thereof. When choosing a protein source, the biological value of the protein should be considered first, with the highest biological values being found in caseinate, whey, lactalbumin, soy, delactosed milk solids, egg albumin and whole egg proteins. These proteins have high biological value; that is, they contain a high proportion of the essential amino acids.

In a preferred embodiment, the preferred protein is whey protein concentrate or other protein with a high biological value to promote protein synthesis (e.g., casein, soy, milk, egg) and provides about 1 to about 50 g protein per serving. The preferred amount of protein is between 1 to 5 grams per serving, more preferable, approximately 3 g per serving.

Fats and Oils

Sources of fats can include but are not limited to vegetable oil, (e.g., canola oil, corn oil, soybean oil, sesame seed oil, safflower oil, sunflower oil, evening primrose oil, peanut oil, cottonseed oil, high oleic sunflower oil, rapeseed oil, olive oil), fish oil (e.g., menhaden oil, sardine oil) and mixtures thereof, all of which are examples of long-chain triglycerides and coconut oil, macadamia oil, palm oil, palm oil, palm kernel oil, or mixtures thereof, all of which are examples of medium-chain triglycerides. Partially hydrogenated oils may also be used. Additional sources of long-chain triglycerides and medium-chain triglycerides are described in U.S. Pat. No. 4,703,062, the entire teachings of which are incorporated herein by reference. The oils can be used in their natural states; alternatively, structured triglycerides, which can be either randomly re-esterified or specifically re-esterified, can be generated from two or more oils and used as a fat source. Structured triglycerides can contain long-chain triglycerides; medium-chain triglycerides; or both long-chain and medium-chain triglycerides.

In a preferred embodiment, the nutritional supplement includes a fat source containing long-chain triglycerides (e.g., canola oil); in another preferred embodiment, the fat sources are provided in an amount sufficient to delay gastric emptying. The nutritional supplement includes from about 1 to about 20 g fat, preferably 1 g to 5 grams of fat, more preferably 3 grams of canola oil.

Further Ingredients

The nutritional supplement can also contain other ingredients such as one or a combination of other vitamins, minerals, antioxidants, fiber and other nutritional supplements. Selection of one or several of these ingredients is a matter of formulation design, consumer and end-user preference. The amount of these ingredients added to the nutritional supplements of this invention are readily known to the skilled artisan and guidance to such amounts can be provided by the RDA and DRI (Dietary Reference Intake) doses for children and adolescents. Vitamins and minerals that can be added include, but are not limited to, calcium phosphate or acetate, tribasic; potassium phosphate, dibasic; magnesium sulfate or oxide; salt (sodium chloride); potassium chloride or acetate; ascorbic acid; ferric orthophosphate; niacin amide; zinc sulfate or oxide; calcium pantothenate; copper gluconate; riboflavin; beta-carotene; pyridoxine hydrochloride; thiamin mononitrate; folic acid; biotin; chromium chloride or picolinate; potassium iodide; selenium; sodium selenate; sodium molybdate; phylloquinone; Vitamin D₃; cyanocobalamin; sodium selenite; copper sulfate; Vitamin A; Vitamin E; vitamin B₆ and hydrochloride thereof; Vitamin C; inositol; Vitamin B₁₂; potassium iodide.

The amount of other ingredients per unit serving are a matter of design and will depend upon the total number of unit servings of the nutritional supplement daily administered to the patient. The total amount of other ingredients will also depend, in part, upon the condition of the patient. Preferably the amount of other ingredients will be a fraction or multiplier of the RDA or DRI amounts. For example, the nutritional supplement will comprise 50% RDI (Reference Daily Intake) of vitamins and minerals per unit dosage and the patient will consume two units per day.

Flavors, coloring agents, spices, nuts and the like can be incorporated into the product. Flavorings can be in the form of flavored extracts, volatile oils, chocolate flavorings (e.g., non-caffeinated cocoa or chocolate, or chocolate substitutes, such as carob), peanut butter flavoring, cookie crumbs, crisp rice, vanilla or any commercially available flavoring. Flavorings can be protected with mixed tocopherols. Examples of useful flavorings include but are not limited to pure anise extract, imitation banana extract, imitation cherry extract, chocolate extract, pure lemon extract, pure orange extract, pure peppermint extract, imitation pineapple extract, imitation rum extract, imitation strawberry extract, or pure vanilla extract; or volatile oils, such as balm oil, bay oil, bergamot oil, cedarwood oil, cherry oil, walnut oil, cinnamon oil, clove oil, or peppermint oil; peanut butter, chocolate flavoring, vanilla cookie crumb, butterscotch or toffee. In a preferred embodiment, the nutritional supplement contains berry or other fruit flavors. The food compositions may further be coated, for example with a yogurt coating, if it is produced as a bar.

Emulsifiers may be added for stability of the final product. Examples of suitable emulsifiers include, but are not limited to, lecithin (e.g., from egg or soy), and/or mono- and di-glycerides. Other emulsifiers are readily apparent to the skilled artisan and selection of suitable emulsifier(s) will depend, in part, upon the formulation and final product.

Preservatives may also be added to the nutritional supplement to extend product shelf life. Preferably, preservatives such as potassium sorbate, sodium sorbate, potassium benzoate, sodium benzoate or calcium disodium EDTA are used.

In addition to the carbohydrates described above, the nutritional supplement can contain artificial sweeteners, e.g., saccharides, cyclamates, aspartamine, aspartame, acesulfame K, and/or sorbitol. Such artificial sweeteners can be desirable if the nutritional supplement is intended for an overweight or obese child or adoloescent.

Manufacture of the Nutritional Supplement

The nutritional supplements of the present invention may be formulated using any pharmaceutically acceptable forms of the vitamins, minerals and other nutrients discussed above, including their salts. They may be formulated into capsules, tablets, powders, suspensions, gels or liquids optionally comprising a physiologically acceptable carrier, such as but not limited to water, milk, juice, sodas, starch, vegetable oils, salt solutions, hydroxymethyl cellulose, carbohydrate. In one embodiment, the nutritional supplements may be formulated as powders, for example, for mixing with consumable liquids, such as milk, juice, sodas, water or consumable gels or syrups for mixing into other nutritional liquids or foods. The powdered form has particular consumer appeal, is easy to administer and incorporate into one's daily regimen, thus increasing the chances of patient compliance. The nutritional supplements of this invention may be formulated with other foods or liquids to provide premeasured supplemental foods, such as single serving bars or beverages, for example.

To manufacture such a beverage, the ingredients are dried and made readily soluble in water or other consumable liquids as described above. The beverage is a preferred nutritional supplement form due to its ability to aid in the sensation of satiety if consumed at least one half hour prior to meals.

To manufacture such a food bar, the dry ingredients are added with the liquid ingredients in a mixer and mixed until the dough phase is reached; the dough is put into an extruder and extruded; the extruded dough is cut into appropriate lengths; and the product is cooled.

For manufacture of other foods or beverages, the ingredients comprising the nutritional supplement of this invention can be added to traditional formulations or they can be used to replace traditional ingredients. Those skilled in food formulating will be able to design appropriate foods/beverages with the objective of this invention in mind.

The nutritional supplement can be made in a variety of forms, such as puddings, confections, (e.g., candy), nutritional beverages, ice cream, frozen confections and novelties, or non-baked, extruded food products such as bars. The preferred form is a powder for a beverage or a non-baked extruded nutritional bar.

In another embodiment, the ingredients can be separately assembled. For example, certain of the ingredients (e.g., the bitter tasting ones) can be assembled into a tablet or capsule using known techniques for their manufacture. The remaining ingredients can be assembled into a powder or nutritional bar, as described herein. The two assembled forms comprise the nutritional supplement and can be packaged together or separately, such as in the form of a kit, as described below. Further, they can be administered together or separately, as desired.

Use of the Nutritional Supplement

Obesity is a heterogeneous group of conditions with multiple causes (Kopelman P. G., Nature, 404: 635-43 (2000)). Body weight is determined by an interaction of genetics, the environment, and energy balance (i.e., the relationship between energy intake and energy expenditure). Energy expenditure has several components. The major one, basal metabolism, accounts for up to two-thirds of the daily total energy needs (Bray, G. A., Contemporary Diagnosis and Management of Obesity, 35-67 (1998)). This includes energy to maintain body temperature, contracting smooth muscles of the heart and gastrointestinal tract, and mobilization of substances like food and oxygen across cell membranes. Another one-tenth of the energy expenditure is dissipated through the thermic effect of food (energy cost of digestion, absorption, and metabolism of food), which is reduced in obesity. Lastly, exercise (physical activity) contributes to energy expenditure, which represents about 20 to 50% of the total (Kopelman, P. G., Nature, 404: 635-43 (2000)).

The active ingredients in the nutritional supplement work to increase the body's rate of energy expenditure. The macronutrient carbohydrate is specifically chosen based on their ability to manage blood glucose levels and increase satiety. Protein and fat create a product with balanced nutrients comparable to a balanced deficit diet.

The composition and dietary supplements of the invention are intended to be orally administered daily. Based on the serving size of about 35 g of an extruded bar the recommended dosage is twice daily. For example, if the supplement is in the form of a food bar or beverage, then the patient would consume one or two mid-afternoon and one or two after dinner, where hunger would cause overeating at the next meal in the first scenario or make one too hungry to fall asleep. Older adolescents can eat more than one bar at a sitting. The recommended daily amounts of each ingredient, as described above, serve as a guideline for formulating the dietary supplements of this invention. The actual amount of each ingredient per unit dosage will depend upon the number of units daily administered to the individual in need thereof. This is a matter of product design and is well within the skill of the dietary supplement formulator.

The ingredients can be administered in a single formulation or they can be separately administered. For example, it may be desirable to administer the bitter tasting ingredients in a form that masks their taste (e.g., capsule or pill form) rather than incorporating them into the nutritional composition itself (e.g., beverage or bar). Thus, the invention also provides a pharmaceutical pack or kit comprising one or more containers filled with one or more of the ingredients of the nutritional compositions of the invention. Optionally associated with such container(s) can be a notice in the form prescribed by a government agency regulating the manufacture, use or sale of pharmaceutical or dietary supplement products, which notice reflects approval by the agency of manufacture, use of sale for human administration. The pack or kit can be labeled with information regarding mode of administration, sequence of administration (e.g., separately, sequentially or concurrently), or the like. The pack or kit may also include means for reminding the patient to take the therapy. The pack or kit can be a single unit dosage of the combination therapy or it can be a plurality of unit dosages. In particular, the agents can be separated, mixed together in any combination, present in a formulation or tablet. Agents assembled in a blister pack or other dispensing means is preferred.

Methods are described for providing a nutritional supplement to overweight and obese children and adolescents, comprising a low-glycemic-index carbohydrate source, a source of protein and a source of fat wherein the amounts of carbohydrate, protein and fat are sufficient for use in children and adolescents to aid in the management of weight loss, preferably the supplement is in the form of a extruded bar (e.g., food) or in the form of a liquid (e.g., beverage).

Also described are methods for providing a pediatric individual with a nutritional supplement consisting essentially of low-glycemic-index carbohydrate, protein and fat, more preferably in the form of a liquid (e.g., beverage) that aids in the feeling of satiety, management of weight gain and promotes weight loss.

All references provided herein are incorporated by reference in their entirety.

### EXAMPLES

### Example 1

### Nutritional Supplement for Management of Weight

In one embodiment, the nutritional supplement is a beverage that provides 120-125 kcal/unit serving, where one unit serving is to be administered twice daily. The nutritional supplement has the following characteristics:

approximately 21 g carbohydrate;

approximately 3 g protein: preferably, whey protein concentrates; soy, casein, or other high biological value proteins may be substituted to improve flavor;

and approximately 3 g fat: preferably canola oil.

### Example 2

### Nutritional Composition of the Food Product

| Nutrient | Amount | kcal | % kcal | Notes |
|---|---|---|---|---|
| Carbohydrate | 21 g | 84 | 69 | Low glycemic |
| | | | | carbohydrate sources |
| | | | | and fiber to promote |
| | | | | satiety |
| Protein | 3 g (3 g whey | 12 | 10 | High biological |
| | protein) | | | value sources |
| Fat | 3 g | 26 | 21 | Monounsaturated |
| | (canola oil) | | | fatty acids (non- |
| | | | | atherogenic) and |
| | | | | could have medium- |
| | | | | chain trigylcerides |
| | | | | (not stored as fat) |

While this invention has been particularly shown and described with references to preferred embodiments thereof, it will be understood by those skilled in the art that various changes in form and details may be made therein without departing from the scope of the invention encompassed by the appended claims.

What is claimed is:

1. A nutritional supplement for overweight and obese children and adolescents, comprising a low-glycemic-index carbohydrate source, a source of protein and a source of fat; wherein the amounts of carbohydrate, protein and fat are sufficient for use in children and adolescents to aid in the management of weight loss.

2. The nutritional supplement of claim 1, wherein the nutritional supplement is in the form of an extruded bar.

3. The nutritional supplement of claim 1, wherein the nutritional supplement is in the form of a liquid.

4. The nutritional supplement of claim 1, wherein the carbohydrate source further provides a source of fiber.

5. The nutritional supplement of claim 1, wherein the protein source is of a high biological value.

6. The nutritional supplement of claim 5, wherein the protein source comprises at least one protein source selected from the group consisting of whey protein concentrate, casein, soy, milk, egg and combinations thereof.

7. The nutritional supplement of claim 1, wherein fat is a non-atherogenic oil or a partially hydrogenated oil.

8. The nutritional supplement of claim 7, wherein the non-atherogenic oil is vegetable oil.

9. The nutritional supplement of claim 8, wherein the vegetable oil is selected from the group consisting of: canola, olive, soy, safflower, sunflower, corn and combinations thereof.

10. The nutritional supplement of claim 1, additionally comprising one or more of the following: micronutrients, dietary supplements, nutrients, and edible compounds.

11. The nutritional supplement of claim 2, wherein the bar further comprises sources of vitamins and minerals.

12. The nutritional supplement of claim 2, wherein the bar further comprises an emulsifier.

13. The nutritional supplement of claim 2, wherein the bar further comprises a flavoring.

14. A nutritional supplement for overweight and obese children and adolescents comprising, for a 100 to 200 kcal/serving, from about 1 to about 75 grams low-glycemic-index carbohydrate, from about 1 to about 20 grams protein and from about 1 to about 20 grams fat; wherein the amounts of carbohydrate, protein and fat are sufficient for use in children and adolescents to aid in the management of weight loss.

15. A nutritional supplement comprising, for a 120-125 kcal serving, from about 10 to about 30 grams low-glycemic-index carbohydrate, from about 1 to about 5 grams protein and from about 1 to about 5 grams fat, wherein the amounts of carbohydrate, protein and fat are sufficient for use in children and adolescents to aid in the management of weight loss.

16. A food or beverage comprising the nutritional supplement of claim 1.

17. A method of providing a pediatric individual with nutritional supplementation that aids in the feeling of satiety, comprising administering to a pediatric individual in need thereof the nutritional supplement of claim 1.

18. A method of providing a pediatric individual with nutritional supplementation that aids in the management of weight gain and promotes weight loss, comprising administering to a pediatric individual in need thereof the nutritional supplement of claim 1.

19. A method of providing a pediatric individual with nutritional supplementation that aids in the prevention of weight gain, comprising administering to a pediatric individual in need thereof the nutritional supplement of claim 1.

20. A nutritional supplement for overweight and obese children and adolescents, consisting essentially of about 21 grams of a low-glycemic-index carbohydrate source, about 3 grams of a source of protein and about 3 grams of a source of fat wherein the amounts of carbohydrate, protein and fat are sufficient for use in children and adolescents to aid in the management of weight loss.
